(19) United States
(12) Patent Application Publication
(10) Pub. No.: US 2026/0097403 A1
(43) Pub. Date: Apr. 9, 2026

(54) REAGENT CARTRIDGES

(71) Applicant: BIOLYPH, LLC, Chaska, MN (US)

(72) Inventors: Timothy E. Pearcy, Eden Prairie, MN (US); Steve Rose, Minneapolis, MN (US)

(21) Appl. No.: 19/113,173

(22) PCT Filed: Sep. 19, 2023
(86) PCT No.: PCT/US2023/074614

§ 371 Date: Mar. 19, 2025

Related U.S. Application Data
(60) Provisional application No. 63/376,260, filed on Sep. 19, 2022.

(51) Int. Cl. B01L 3/00

(52) U.S. Cl. CPC B01L 3/523; B01L 2200/0689; B01L 2300/0832; B01L 2300/0858

(57) ABSTRACT

A reagent cartridge includes a cartridge body configured to store a reagent component. The cartridge body includes at least one cartridge wall surrounding at least a portion of a reagent envelope, the reagent envelope configured for storage of the reagent component. The cartridge body includes a shelf surrounding an access port, the access port in communication with the reagent envelope. The reagent cartridge includes a seal coupled with the shelf and the seal closes the access port. The seal and the cartridge body cooperatively isolate the reagent envelope from an environment exterior to the reagent envelope.

### CLAIM OF PRIORITY

This patent application claims the benefit of priority of Pearcy et al. U.S. Provisional Patent Application Ser. No. 63/376,260, entitled “REAGENT CARTRIDGES,” filed on Sep. 19, 2022 (Attorney ocket No. 1886.018PRV), which is hereby incorporated by reference herein in its entirety.

### TECHNICAL FIELD

This document pertains generally, but not by way of limitation, to reagent storage and reconstitution.

### BACKGROUND

In an example, a reagent is used for diagnostic tests (e.g. blood tests, genetic testing, drug discovery, or the like). For instance, the reagent is stored in a container, and the reagent is collected from the container for use in the chemical analysis. For example, the container includes foil, and the reagent is stored therein. In another approach, the reagent is stored in a glass (or plastic) container with a seal. For instance, the reagent is kept in a well, and once opened is manually dumped into a test tube for reconstitution.

### SUMMARY

The present inventors have recognized, among other things, that a problem to be solved can include isolation of a reagent. In some examples, a reagent decomposes when exposed to moisture. Additionally, the present inventors have recognized, among other things, that a problem to be solved can include foil or plastic wrapped reagents. For instance, the foil or plastic wrapped reagents are cut open to access the reagents. In another approach, the reagents are added to a container, and a precise amount of diluent is added to the container by a skilled technician using a pipette to reconstitute the reagent without diluting the reagent (or leaving reagent unreconstituted). Accordingly, the use of foil or plastic wrapped reagents, and their reconstitution, is laborious and time-consuming. Further, the use of foil or plastic wrapped reagents often requires a large degree of precision to properly reconstitute the reagent.

Further, the present inventors have recognized, among other things, that a problem to be solved can include reagents stored in glass or plastic ampoules. In an approach, the ampoule needs to be crushed in order to access the reagent contained therein. Accordingly, a reconstitution system is needed that includes mechanical features configured to crush the ampoule safely, and then reconstitute the reagent contained therein.

The present subject matter can help provide a solution to this problem, such as with a reagent cartridge. The reagent cartridge includes a reagent component isolated within a reagent envelope. For instance, the reagent envelope (e.g., a cartridge wall, seals, or the like) isolates the reagent component from an environment by the envelope. In another example, the reagent component is lyophilized (e.g., dried, freeze-dried, desiccated, or the like). The cartridge includes one or more features, for instance access ports, seals, or the like that isolate the reagent component, and provide access for reconstitution of the reagent component (e.g., with diluent, or the like) and evacuation of reconstituted reagent from the reagent cartridge. The reagent cartridge examples described herein provide ready access to the reagent.

Additionally, the reagent cartridge provides a well for reconstitution of the reagent component. Diluent is received within the well to facilitate reconstitution, and the reconstituted reagent is extracted from the well. As discussed herein, extraction is conducted in one or more permutations. In some examples, the reagent cartridge facilitates washing of the diluent through the well to reconstitute the reagent component. In another example, the reconstituted reagent is delivered to a location for testing (e.g., a reservoir including a specimen). For example, the cartridge includes a cartridge wall having a tapered profile, and in one of these examples the tapered profile is vertical (including a vertical orientation that is angled relative to true vertical, such as 0 to 15 degrees or the like). The reagent component (or reconstituted reagent) is guided for collection by the tapered profile. For instance, in an example, the taper guides and collects the reconstituted reagent in a funneled well, and a pipette is used to evacuate all of the reconstituted reagent with assistance provided by the tapered profile.

In other examples, the tapered profile is horizontal. The cartridge having the tapered profile receives diluent to reconstitute the reagent and the flow of diluent (and optionally gravity or the force of the flow in cooperation with the taper) carries the reconstituted reagent from the cartridge downstream to a testing assembly. Accordingly, the cartridge is, in one example, used as pipe, tube or the like that contains the reagent, receives a flow of diluent, and washes the reconstituted reagent downstream.

In another example, the reagent cartridge is coupled with a reconstitution assembly in a vertical orientation (including a vertical orientation that is angled relative to true vertical, such as 0 to 15 degrees or the like). The reagent cartridge contains the reagent component, and the reagent component is reconstituted in a well of reagent cartridge. For example, a first piercing element pierces a first seal and provides access to the reagent envelope through a first access port. The first piercing element (or another instrument) introduces a diluent into the reagent cartridge through the first access port. the diluent reconstitutes the reagent component within the reagent cartridge, for instance in a well of the reagent envelope. A second piercing element pierces a second seal and provides access to the reagent envelope through a second access port. The reconstituted reagent is evacuated through the second access port using the second piercing element or another instrument. Thus, in this example the first access port permits reconstitution of the reagent component, and the second access port permits evacuation of the reconstituted reagent from the reagent container.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A shows a perspective exploded view of an example of a reagent cartridge.

FIG. 1B shows a cross-sectional exploded view of the reagent cartridge of FIG. 1A.

FIG. 1C shows another cross-sectional view of the reagent cartridge of FIG. 1A.

FIG. 2A shows a perspective exploded view of another example of a reagent cartridge.

FIG. 2B shows a cross-sectional exploded view of the reagent cartridge of FIG. 2A.

FIG. 2C shows another cross-sectional view of the reagent cartridge of FIG. 2A.

FIG. 2D shows yet another cross-sectional view of the reagent cartridge of FIG. 2A.

FIG. 2E shows still yet another cross-sectional view of the reagent cartridge of FIG. 2A.

FIG. 3A shows a perspective exploded view of yet another example of a reagent cartridge.

FIG. 3B shows a cross-sectional exploded view of the reagent cartridge of FIG. 3A.

FIG. 3C shows another cross-sectional view of the reagent cartridge of FIG. 3A.

FIG. 3D shows yet another cross-sectional view of the reagent cartridge of FIG. 3A.

FIG. 4A shows a perspective exploded view of still yet another example of a reagent cartridge.

FIG. 4B shows a cross-sectional exploded view of the reagent cartridge of FIG. 4A.

FIG. 5A shows a perspective exploded view of a further example of a reagent cartridge.

FIG. 5B shows a cross-sectional exploded view of the reagent cartridge of FIG. 5A.

FIG. 6 shows a cross-sectional exploded view of a still further example of a reagent cartridge.

FIG. 7 shows one example of a method of using a reagent cartridge.

### DETAILED DESCRIPTION

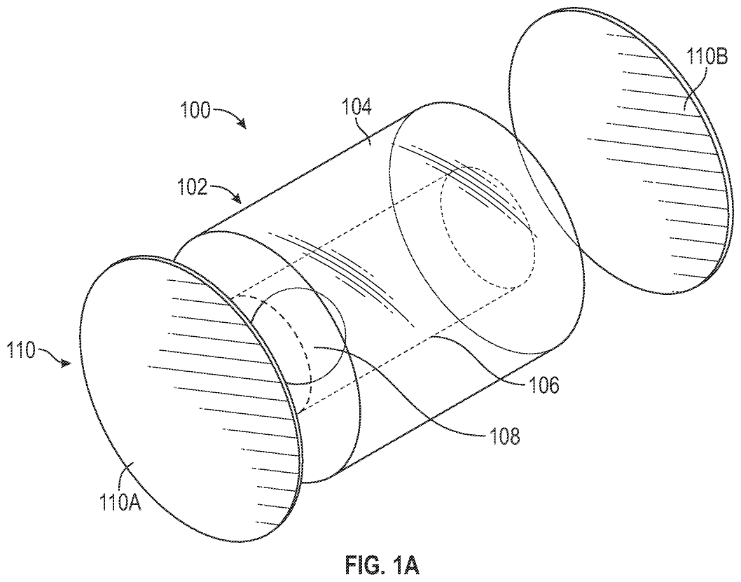

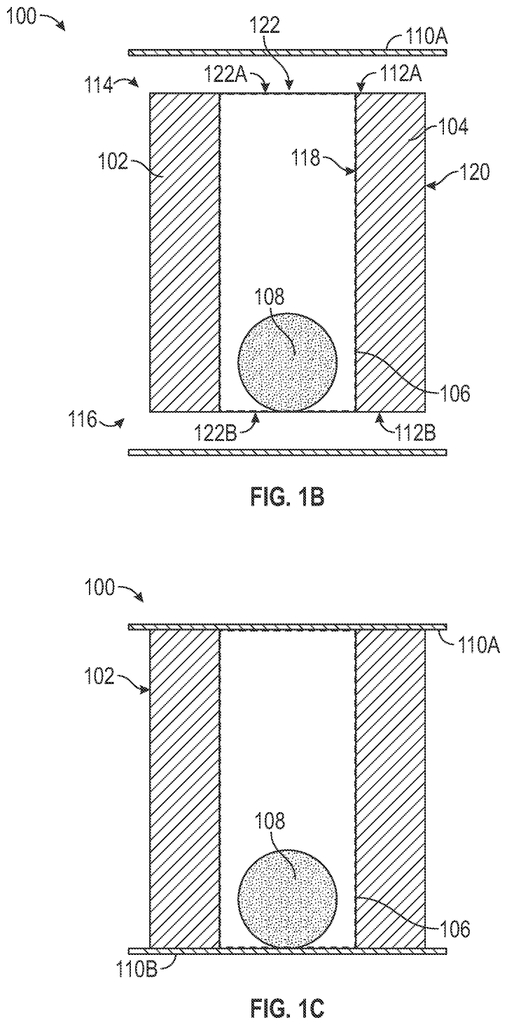

FIG. 1A shows an exploded view of an example reagent cartridge 100. The reagent cartridge 100 has a cartridge body 102 including a cartridge wall 104. The cartridge wall 104 optionally includes a plurality of layers. For example, the cartridge wall 104 includes layers of plastic, intervening air cavities between the layers of plastic, desiccant layers between the layers of plastic, or the like.

The cartridge wall 104 surrounds at least a portion of a reagent envelope 106 shown in dashed lines in FIG. 1A. The reagent envelope 106 contains a reagent component 108, such as a lyophilized reagent. The reagent envelope 106 isolates the reagent component 108 from an environment exterior to the reagent envelope 106 that may otherwise contaminate or dilute the reagent component.

In an example, reagent component 108 is in a dried form or a liquid form. For instance, the reagent component 108 is lyophilized (e.g., dried, freeze-dried, desiccated, or the like). The lyophilized reagent component 108 is reconstituted, for instance by introducing a diluent (e.g., deionized water, or the like) into the reagent envelope 106 that rehydrates the reagent and provides a reagent solution. In an example, the reagent cartridge 100 includes one or more seals 110 (110A, 110B in FIG. 1A). In another example, the seals 110 include one or more of a foil, a polymer film, combinations of the same, laminates of the same, or the like that are hydrophobic and impermeable (e.g., have limited permeability). For example, the reagent cartridge includes a first seal 110A and a second seal 110B. The seals 110 are coupled with the cartridge body 102. The seals 110 cooperate with the cartridge body 102 to isolate the reagent envelope 106 from exposure to an environment. For instance, the seals 110 and the cartridge body throttle a moisture vapor transmission rate between the environment and the reagent envelope. In another example, the seals 110 minimize ingress of air, moisture, or the like into the reagent envelope 106 through access ports closed by the seals.

As described herein, in various examples the one or more seals 110 are punctured to conduct reconstitution and evacuation of the reconstituted reagent from the reagent envelope 106. In one example, a seal 110B closing a first access port for the reagent envelope is penetrated for the to introduce a diluent to the reagent envelope 106 for reconstitution. In another example, the reconstituted reagent is evacuated from the reagent envelope 106 through the access port opened with the penetrated seal 110B. In still another example, the seal 110A is punctured to evacuate (e.g., remove, withdraw, or the like) the reconstituted reagent from the reagent envelope 106. As discussed herein evacuation of the reagent from a cartridge with plural access ports is conducted in the manner of a tube or pipe located within a larger system that permits the flow of the reagent solution through the cartridge. Optionally, the taper, orientation, both or the like facilitates the evacuation of the reagent solution.

FIG. 1B shows a cross-sectional exploded view of the reagent cartridge 100 of FIG. 1A. FIG. 1B shows the cartridge body 102 includes one or more cartridge shelves 112 (e.g., a ledge, flange, or the like). For instance, a first end portion 114 of the cartridge body 102 has a first cartridge shelf 112A. A second end portion 116 of the cartridge body 102 has a second cartridge shelf 112B. In an example, the cartridge shelves 112 extend between an inner wall surface 118 of the cartridge body 102 and an outer wall surface 120 of the cartridge body 102. The cartridge shelves 112 provide an expansive surface for coupling with the seals 110. For instance, the cartridge shelves 112 provide a surface for coupling with the respective seals 110 instead of coupling the seals 110 along edges proximate to the inner wall surface 118.

As shown in this embodiment, the first seal 110A is coupled with the first cartridge shelf 112A closes the first end portion 114. The second seal 110B is coupled with the second cartridge shelf 112B and closes the second end portion 116. The seals 110 and the cartridge body 102 cooperatively isolate the reagent envelope 106 from an environment.

The reagent cartridge 100 includes one or more access ports 122. As discussed herein, the access ports 122 facilitate reconstitution of reagent and evacuation of reconstituted reagent from the reagent envelope 106. In an example, the first cartridge shelf 112A surrounds a first access port 122A. In another example, the second cartridge shelf 112B surrounds a second access port 122B. The access ports 122 communicate with the reagent envelope 106.

FIG. 1C shows another cross-sectional view of the reagent cartridge of FIG. 1A in an assembled configuration. The first seal 110A is coupled with the cartridge body 102 along the first shelf 112A (shown in FIG. 1B). The second seal 110B is coupled with the cartridge body 102 along the second shelf 112B (shown in FIG. 1B). As previously discussed the shelves 112A, B provide an expansive surfaces for coupling with the respective seals 110A, B. The seals 110A, B and their robust coupling along the expansive surfaces enhance impermeability at the access ports 122A, B (see FIG. 1B). The seals 110 and the cartridge body 102 thereby cooperatively isolate the reagent envelope 106 (shown in dashed lines in FIG. 1C) from exposure to an environment exterior to the reagent envelope 106.

The cartridge body 102 is constructed in one example as a cleaved section of an extruded lineal tube. The cartridge body 102 is optionally cleaned and coupled with one or more components including a jacket that enhances impermeability of the cartridge material, a desiccant layer or the like. In another example, the cartridge body 102 is injection molded, pultruded or the like.

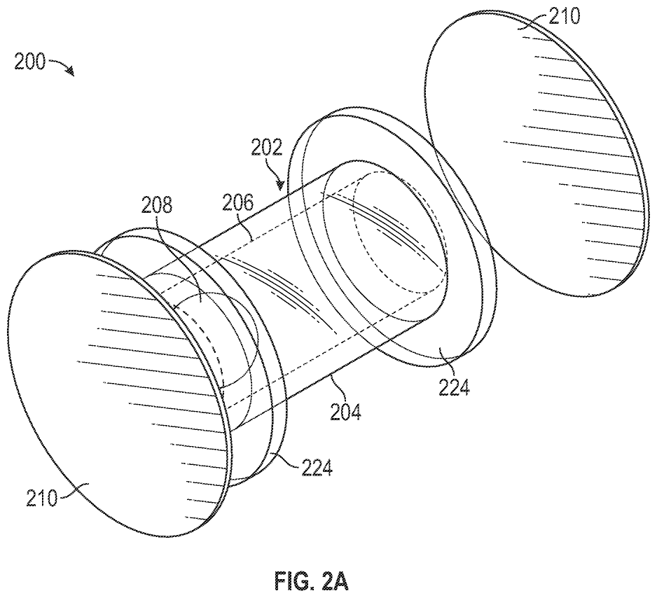

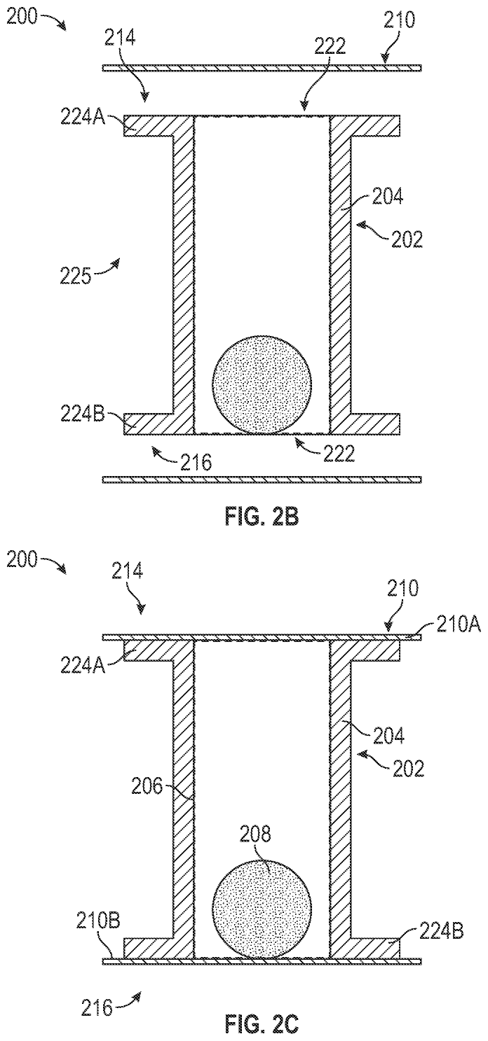

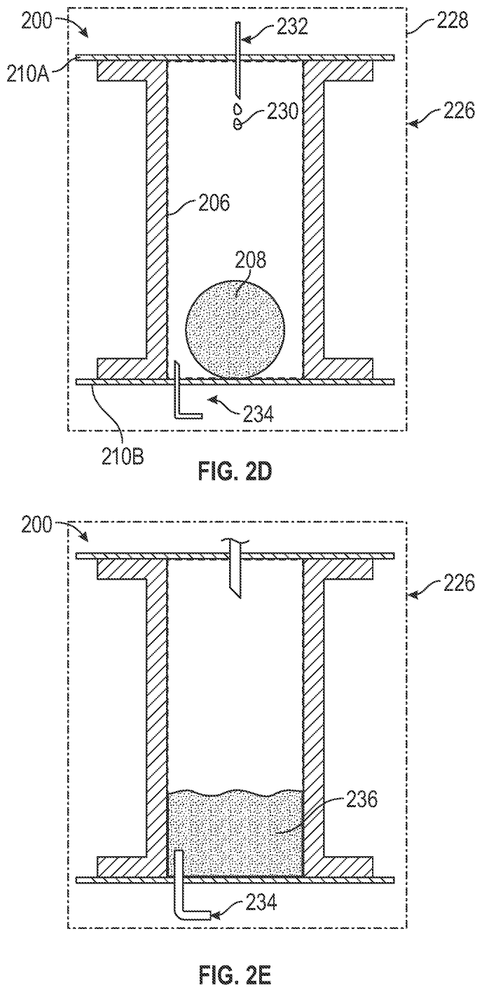

FIG. 2A shows a perspective exploded view of another example of a reagent cartridge 200. In an example, the reagent cartridge 200 includes cartridge body 202, cartridge wall 204, reagent envelope 206 (shown in dashed lines in FIG. 2A), reagent component 208 and the seals 210. The reagent cartridge 200 optionally includes one or more flanges 224. In this example, one or more shelves 212 include the flanges 224 extending from a remainder of the cartridge body 102. The flanges 224 provide enhanced surface area for coupling of the cartridge body with the seals 110. In another example, the flanges 224 are used as an indexing feature 226 for accurate loading of the reagent cartridge 200 into a reconstitution assembly.

In an example, the flanges 224A, 224B are shelves for coupling of the seals 210 to the cartridge body 202. A recessed area 225 between the flanges 224A, 224B can be enclosed with another wall to provide a layered wall including an outer wall, air, noble gas, or vacuum cavity, and inner wall (e.g., cartridge wall 204, or the like). In another example, the recessed area 225 is loaded with a desiccant.

FIG. 2B shows a cross-sectional exploded view of the reagent cartridge 100 of FIG. 2A. The flanges 224 include a first flange 224A at the first end portion 114 of the cartridge body 102. The flanges 224 include a second flange 224B at the second end portion 216 of the cartridge body 202. In an example, the flanges 224 surround the access ports 222. In another example, the flanges 224 extend away from the cartridge wall 204. In yet another example, the flanges 224 enhance coupling between the seals 210 and the cartridge body 202.

FIG. 2C shows another cross-sectional view of the reagent cartridge 200 of FIG. 2A. A first seal 210A is coupled with the first flange 224A. For instance, the first seal 210A cooperates with the first flange 224A to close (e.g., seal, isolate, enclose, restrict, confine, or the like) a first end portion 214 of the reagent cartridge 200. A second seal 210B is coupled with the second flange 224B. For example, the second seal 110B cooperates with the second flange 224B to close the second end portion 116 of the reagent cartridge 100. Accordingly, the reagent envelope 206 (shown in dashed lines in FIG. 2C) is isolated from exposure to an environment exterior to the reagent envelope 206. For instance, the seals 210 cooperate with the flanges 224 and the remainder of the cartridge body 202 to isolate the reagent envelope 206 (and the reagent component 208 contained therein) from exposure to an environment exterior to the reagent envelope 206.

FIG. 2D shows a cross-sectional view of the reagent cartridge 200 of FIG. 2A in example reconstitution and extraction configurations. The reagent cartridge 200 is contained within a reconstitution assembly 226. For example, the reagent cartridge 100 has a cartridge profile. The cartridge profile is readily received in a complementary socket 228 of the reconstitution assembly 226. The reconstitution assembly 226 facilitates introduction of diluent 230 into the reagent envelope 206, reconstitution in the envelope 206, and evacuation of a reconstituted reagent from the reagent envelope 206 in a controlled environment to permit automated testing of specimens.

The reconstitution assembly 226 facilitates reconstitution of the reagent component 208 located in the reagent envelope 206. For example, the reconstitution assembly 226 includes a first piercing element 232 that pierces the first seal 210A. In an example, the first piercing element 232 optionally introduces diluent 230 into the reagent envelope 206. The diluent 230 mixes with the reagent component 208 and reconstitutes reagent within the reagent envelope 206.

FIG. 2D further shows the reconstitution assembly 226 includes a second piercing element 234. The second piercing element 234 (e.g., a needle, syringe, or the like) pierces the second seal 210B. In an example, the second piercing element 234 evacuates the reagent previously reconstituted in the reagent envelope 206. For instance, second piercing element 234 applies suction, works with gravity or the like to evacuate the reagent from the reagent envelope 206. Accordingly, the reconstitution assembly 226 facilitates introduction of diluent 230 into the reagent envelope 206, reconstitution in the envelope 206 and evacuation of a reconstituted reagent from the reagent envelope 106.

FIG. 2E shows still yet another cross-sectional view of the reagent cartridge 200 of FIG. 2A with the reagent reconstituted to a liquid form. The reagent component 208 (shown in FIG. 2D) has been reconstituted with the diluent 230 (shown in FIG. 2D). In this example embodiment, the second piercing element 234 of the reconstitution assembly 226 is then penetrated through the second seal 210B to evacuate the reconstituted reagent 236 from the reagent envelope 206. In another example, one or more of the seals 210 are unsealed (e.g., pierced, punctured, removed, opened, peeled, separated, torn off, or the like) to allow the reconstituted reagent 212 to drain from the reagent cartridge 100.

Referring again to FIGS. 2A-2E, in an example, the diluent 230 is introduced into the reagent envelope 206 through the first access port 222A. The reagent component 208 is reconstituted in the reagent envelop 206. The reconstituted reagent 236 is evacuated from the reagent envelope through the second access port 222B. Accordingly, the reconstitution assembly 226 permits staged reconstitution and then evacuation of reconstituted reagent 236 from the reconstitution assembly 226. Thus, the cartridge 200 is, in one example, used as pipe, tube or the like that contains the reagent, receives a flow of diluent, and washes the reconstituted reagent downstream. In an example, reagent cartridges 400, 500, and 600 are reconstituted in a similar manner to reagent cartridge 200.

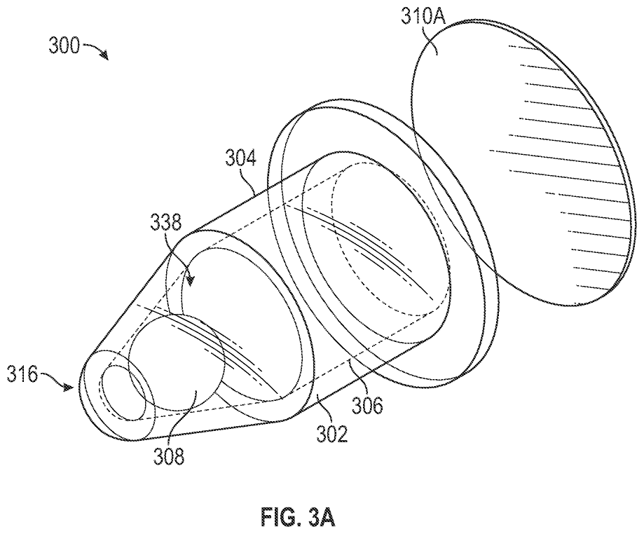

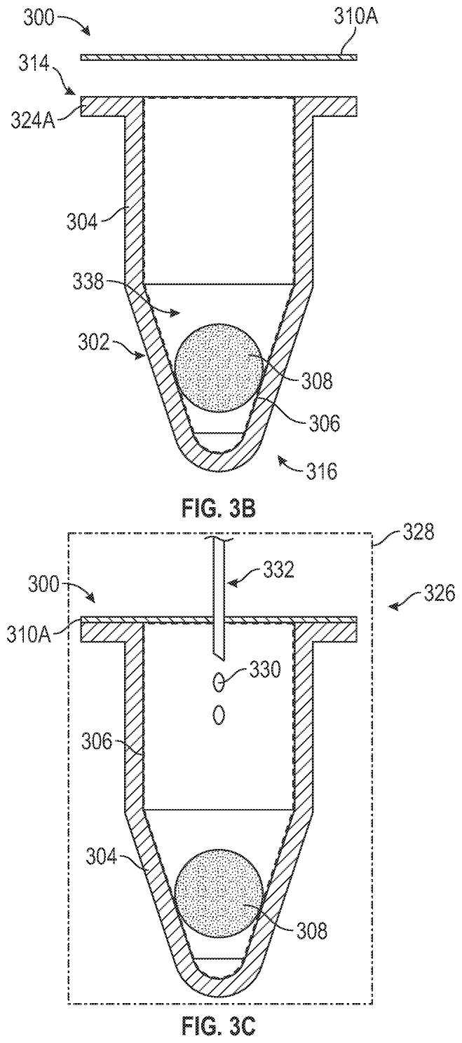

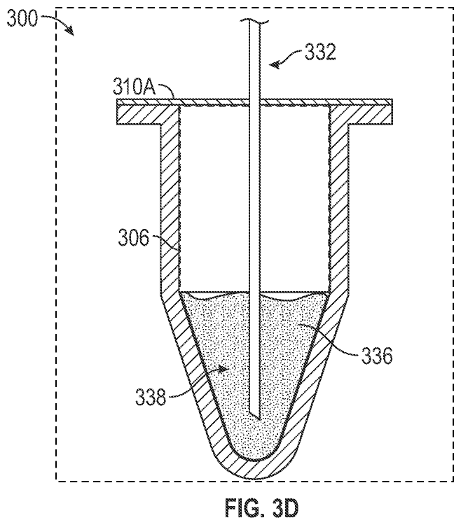

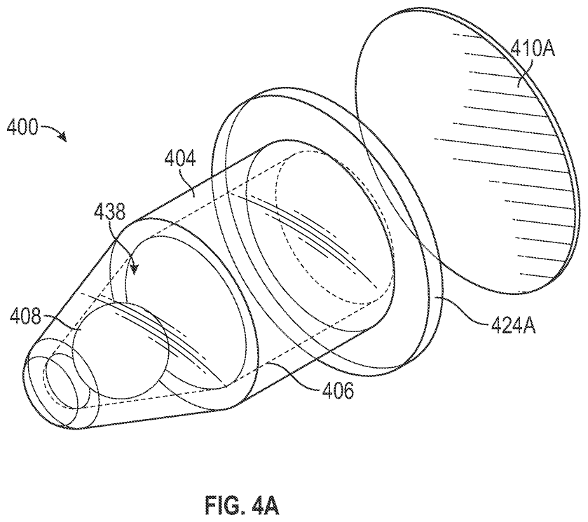

FIGS. 3A and 3B show exploded perspective and exploded cross-sectional views (respectively) of yet another example of a reagent cartridge 300. In an example, the reagent cartridge 300 includes cartridge body 302, cartridge wall 304, reagent envelope 306 (shown in dashed lines in FIGS. 3A and 3B), reagent component 308, seal 310A, and flange 300A. In an example, the cartridge wall 304 has a tapered profile. For instance, second end portion 316 of the cartridge body 302 narrows away from first end portion 314 of the cartridge body 302. In another example, the second end portion 316 of the cartridge body 302 is sealed. Accordingly, in some examples, the cartridge wall 304 provides a well 338. The well 338 is a tapered feature (e.g., a funnel, guide or the like) of the cartridge wall 304 that correspondingly tapers the reagent envelope 306. For instance, the well 338 retains the reagent 308 at a specified location and guides reconstitution and retention of the reconstituted reagent to the specified location of the reagent envelope 306. The guidance of the reconstituted reagent to the specified location, such as the tapered or funneled well 338 facilitate collection of the reconstituted reagent 336 (shown in FIG. 3D) within the reagent envelope 306.

FIG. 3C shows another cross-sectional view of the reagent cartridge 300 of FIG. 3A. The reagent cartridge 300 is received in reconstitution assembly 326. As described herein, the reconstitution assembly 326 facilitates reconstitution of the reagent component 308. For instance, the first piercing element 332 optionally pierces the seal 310A to introduce the diluent 330 into the reagent envelope 306. Accordingly, the diluent 330 mixes with the reagent component 308 to provide a reconstituted reagent, for example the reconstituted reagent 336 shown in FIG. 3D.

FIG. 3D shows yet another cross-sectional view of the reagent cartridge 300 of FIG. 3A. The first piercing element 332 is optionally used evacuate the reconstituted reagent 336 from the reagent envelope 306. For example, the first piercing element 332 extends into the well 338 of the reagent cartridge 300. Accordingly, the first piercing element 332 collects the reconstituted reagent 212 from the well 338.

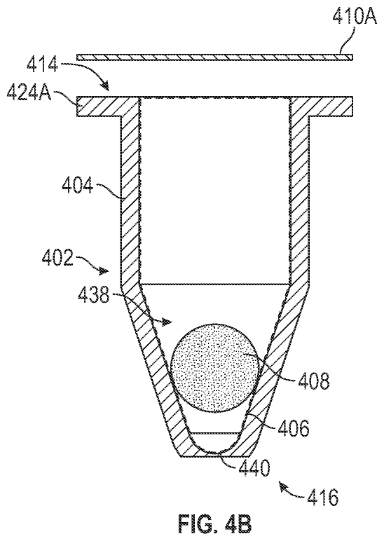

FIGS. 4A and 4B show exploded perspective and exploded cross-sectional views (respectively) of still yet another example of the reagent cartridge 400. In an example, the reagent cartridge 400 includes cartridge body 402, cartridge wall 404, reagent envelope 406 (shown in dashed lines in FIGS. 4A and 4B), reagent component 408, seal 410A, and flange 424A (e.g., in this example a shelf of the reagent cartridge, or the like). In another example, the reagent cartridge 400 includes well 438 the facilitates collection of the reagent component 408 within the reagent envelope 406.

In an example, the second end portion 116 of the cartridge body 104 is sealed. In this example, the second end portion 116 of the of the cartridge body 102 optionally has a fracture locus 440. For instance, the fracture locus 440 has a dissimilar thickness (e.g., is thinner, less thick, or the like) with respect to the cartridge wall 404. In another example, the facture locus 440 is more brittle than the remainder of the cartridge body 404. The fracture locus 440 of the cartridge body 402 is opened through fracture (e.g., puncture, cracking, splitting, or the like) to provide access to the reagent component 408. For instance, the fracture locus 440 is fractured to evacuate one or more of the reagent component 408 or a reconstituted reagent from the reagent envelope 406. In another example, a reconstitution assembly (e.g., reconstitution assembly 326 shown in FIG. 3C, or the like) fractures the fracture locus 400.

The fracture locus 440 permits opening of the cartridge body 404 while obviating an additional access port and seal for the access port. Instead, the material of the cartridge body 404 encloses the reagent envelope 406 (including portions that in other examples are closed with seals) until the locus 440 is broken. Optionally, each of the sealed access ports described herein is replaced with a fracture locus 440 to decrease seals for the cartridges.

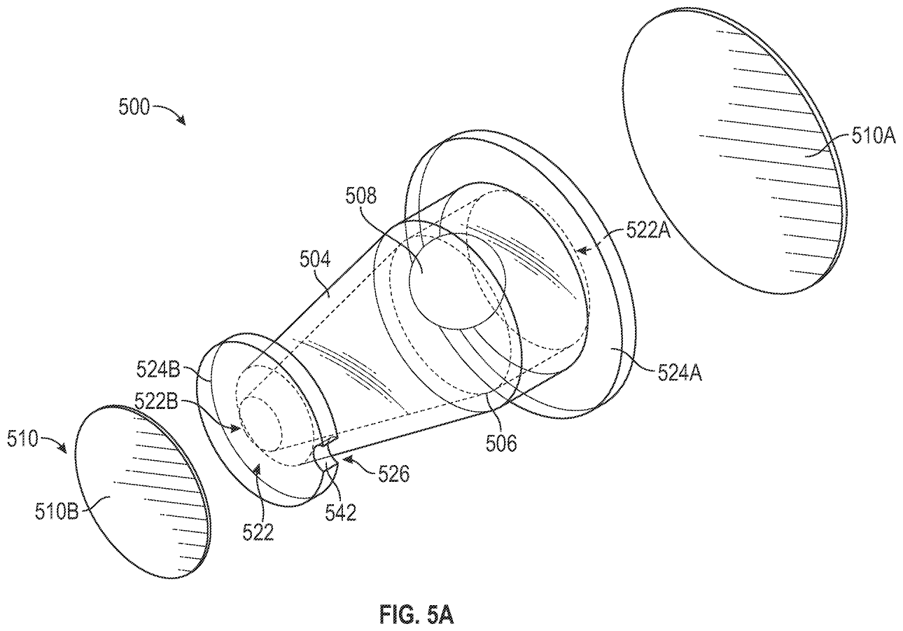

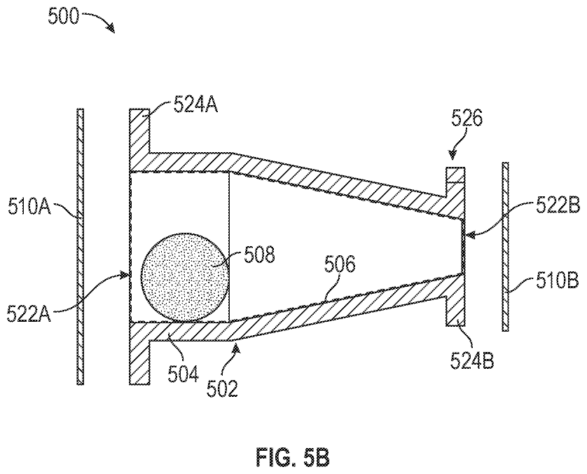

FIGS. 5A and 5B show perspective and cross-sectional views (respectively) of a further example of the reagent cartridge 500. In an example, the reagent cartridge 500 includes cartridge body 502, cartridge wall 504, reagent envelope 506 (shown in dashed lines in FIGS. 5A and 5B), reagent component 508, seals 510, access ports 522, and flanges 524. The first seal 510A 11 closes the first access port 522A. The second seal 510B closes the second access port 522B. Accordingly, the reagent envelope 506 is isolated from an environment exterior to the reagent envelope 506.

In an example, the cartridge wall 504 has a tapered profile. For instance, the second end portion 516 of the cartridge body 502 narrows away from the first end portion 514 of the cartridge body 502. For example, the tapered profile guides one or more of the reagent component or a reconstituted reagent toward an access port, for instance the second access port 522B. In another example, the cartridge wall 504 having the tapered profile narrows toward the second access port 522B. The tapered profile collects and guides the reagent component 508 within the reagent envelope 506. For instance, the tapered profile collects and guides the reagent component 508 (or a reconstituted reagent) for evacuation by an instrument through the second access port 522B.

The tapered profile of the cartridge wall 504 optionally varies from what is shown in FIGS. 5A, 5B. For instance, the portion of the cartridge wall having the tapered profile is optionally smaller than what is shown in FIGS. 5A, 5B. Stated another way, the section of the cartridge wall that tapers is optionally shorter than what is shown in FIGS. 5A, 5B. In another example, the reagent cartridge 500 is provided in a vertical configuration (instead of the horizontal configuration shown in FIG. 5B).

In another example, the reagent cartridge 500 includes indexing feature 526 for accurate loading of the reagent cartridge 100 into a reconstitution assembly. For instance, the indexing feature 526 facilitates unidirectional coupling of the reagent cartridge 500 with the reconstitution assembly. For example, the indexing feature 526 includes a keyway 542 that receives a component of the reconstitution assembly and facilitates accurate loading of the reagent cartridge 500 into the reconstitution assembly. In yet another example, the flange 534B is used as a key for accurate loading of the reagent cartridge 500 into the reconstitution assembly. In still yet another example, the indexing feature 526 includes one or more of a slot, groove, indentation, notch, or the like.

In some examples, the reagent cartridge 100 is coupled with a reconstitution assembly (e.g., reconstitution assembly 204 shown in FIG. 2D, or the like) in a horizontal configuration (including a horizontal orientation that is angled relative to true horizontal, such as 0 to 15 degrees or the like). FIG. 5B shows the reagent cartridge in a horizontal configuration. In another example, the reagent cartridge 100 is coupled with the reconstitution assembly in a vertical configuration (including a vertical orientation that is angled relative to true vertical, such as 0 to 15 degrees or the like). FIG. 2E shows the reagent cartridge in a vertical configuration.

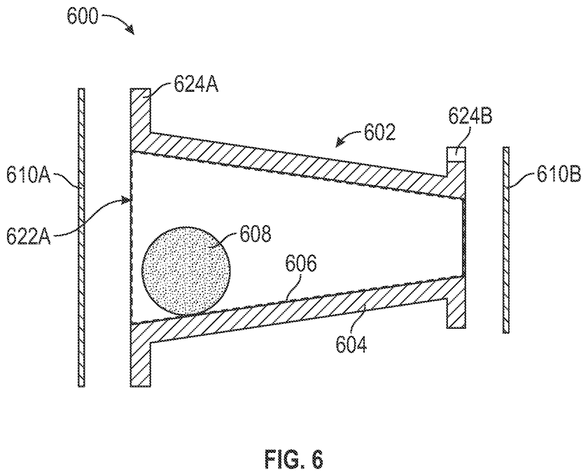

FIG. 6 shows a cross-sectional view of a still further example of the reagent cartridge 600. In an example, the reagent cartridge 600 includes cartridge body 602, cartridge wall 604, reagent envelope 606 (shown in dashed lines in FIG. 6), reagent component 608, seals 610A and 610B, and flanges 624A and 624B. FIG. 6 shows the cartridge wall 604 having the tapered profile. For example, the tapered profile widens toward the first access port 622 A. In an example, the tapered profile minimizes retention of a reconstituted reagent within the reagent envelope 106.

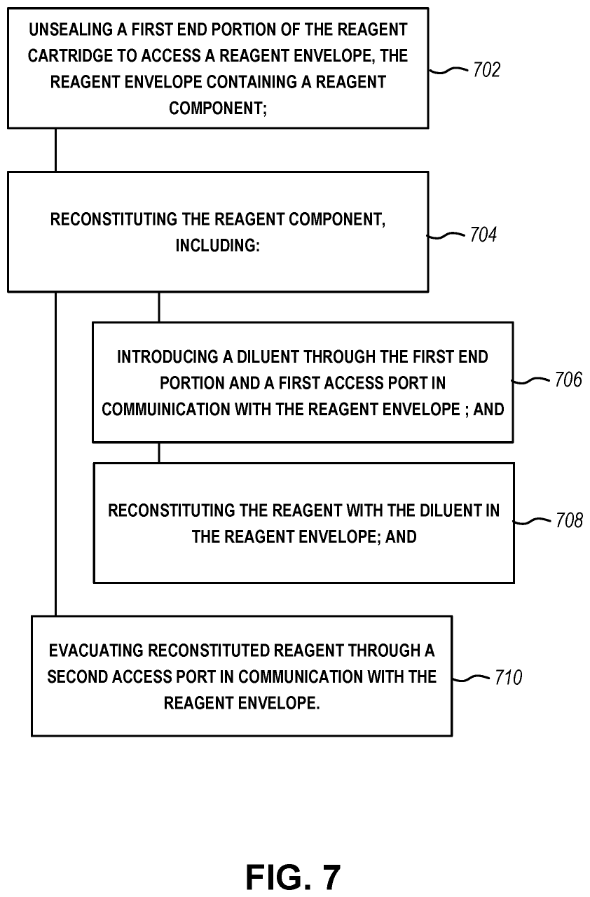

FIG. 7 shows one example of a method 700 of using a reagent cartridge, for instance one or more of the reagent cartridges 100, 200, 300, 400, 500, 600. In describing the method 700, reference is made to one or more components, features, functions and operations previously described herein.

Where convenient, reference is made to the components, features, operations and the like with reference numerals. The reference numerals provided are exemplary and are not exclusive. For instance, components, features, functions, operations and the like described in the method 700 include, but are not limited to, the corresponding numbered elements provided herein and other corresponding elements described herein (both numbered and unnumbered) as well as their equivalents.

At 702, the method 700 includes unsealing a first end portion 114 of a reagent cartridge 100 to access a reagent envelope 106 containing a reagent component 108. The method 700 includes at 704 reconstituting the reagent component. For example, at 706, the method includes introducing a diluent through the first end portion 114 and a first access port 122A in communication with the reagent envelope 106. In another example, the method 700 includes at 708 reconstituting the reagent component 108 with the diluent 230 in the reagent envelope 106. At 710, method 700 includes evacuating reconstituted reagent through a second access port 122B in communication with the reagent envelope 106.

Several options for the method 700 follow. In an example, evacuating reconstituted reagent from the reagent envelope includes unsealing a second end portion 116 of the reagent cartridge 100 to access the reagent envelope 106, wherein the second end portion 116 of the reagent cartridge 100 has the second access port. In this example, the reconstituted reagent 236 is evacuated through the second access port 122B. In another example, unsealing the second end portion 116 of the reagent cartridge 100 includes fracturing the reagent cartridge 100 at a fracture locus 440. In yet another example, unsealing the first end portion 114 of the reagent cartridge includes piercing a seal 110A. In still yet another example, unsealing the first end portion 114 of the reagent cartridge 100 includes removing a seal 110A from the reagent cartridge 100. In a further example, the method 700 includes passing an instrument (e.g., a pipette, needle, piercing element, or the like) through an access port 122A at the first end portion 114 of the reagent cartridge 100.

### Various Notes & Aspects

Example 1 is a reagent cartridge comprising: a cartridge body configured to store a reagent component, the cartridge body includes: at least one cartridge wall surrounding at least a portion of a reagent envelope, the reagent envelope configured for storage of the reagent component; and a shelf surrounding an access port, the access port in communication with the reagent envelope; and a seal coupled with the shelf and the seal closes the access port, wherein the seal and the cartridge body cooperatively isolate the reagent envelope from an environment exterior to the reagent envelope.

In Example 2, the subject matter of Example 1 optionally includes wherein: the shelf includes a first shelf and a second shelf; the access port includes a first access port and a second access port; the first shelf surrounds the first access port; the second shelf surrounds the second access port; the seal includes a first seal and a second seal; the first seal is coupled with the first shelf, and the first seal closes the first access port; and the second seal is coupled with the second shelf, and the second seal closes the second access port.

In Example 3, the subject matter of any one or more of Examples 1-2 optionally include wherein the cartridge wall has a tapered profile.

In Example 4, the subject matter of Example 3 optionally includes wherein the tapered profile narrows toward the access port.

In Example 5, the subject matter of any one or more of Examples 3-4 optionally include wherein the tapered profile widens toward the access port.

In Example 6, the subject matter of any one or more of Examples 1-5 optionally include wherein the cartridge body has an indexing feature configured to orient the reagent cartridge with respect to a reconstitution assembly.

In Example 7, the subject matter of Example 6 optionally includes wherein the indexing feature includes a keyway provided on the cartridge body.

In Example 8, the subject matter of any one or more of Examples 6-7 optionally include wherein the indexing feature includes a key provided on the cartridge body.

In Example 9, the subject matter of any one or more of Examples 6-8 optionally include wherein the shelf includes a flange extending away from the cartridge wall, and the indexing feature is included in the flange.

In Example 10, the subject matter of any one or more of Examples 1-9 optionally include wherein cartridge body includes a fracture locus, and the fracture locus is configured to preferentially fracture proximate an end of the cartridge body.

In Example 11, the subject matter of Example 10 optionally includes wherein the cartridge wall has a tapered profile, and the tapered profile guides reconstituted reagent toward the fracture locus.

In Example 12, the subject matter of any one or more of Examples 1-11 optionally include wherein the shelf includes a flange extending away from the cartridge wall.

In Example 13, the subject matter of Example 12 optionally includes wherein the shelf extends between an inner wall surface and an outer wall surface.

In Example 14, the subject matter of any one or more of Examples 1-13 optionally include wherein the access port is configured to receive a penetrating element to provide diluent to the reagent component.

In Example 15, the subject matter of Example 14 optionally includes wherein: the shelf includes a first shelf and a second shelf, the access port includes a first access port and a second access port; the first shelf surrounds the first access port; the second shelf surrounds the second access port; the penetrating element is a first penetrating element, and the first access port is configured to receive the first penetrating element; and the second access port is configured to receive a second penetrating element to evacuate a reconstituted reagent from the reagent envelope, the reconstituted reagent including the diluent and the reagent component.

In Example 16, the subject matter of any one or more of Examples 14-15 optionally include wherein the penetrating element is configured to evacuate a reconstituted reagent from the reagent envelope, the reconstituted reagent including a diluent and the reagent component.

In Example 17, the subject matter of any one or more of Examples 1-16 optionally include wherein the access port is configured to receive a penetrating element to evacuate a reconstituted reagent, the reconstituted reagent including a diluent and the reagent component.

In Example 18, the subject matter of Example 17 optionally includes wherein the cartridge wall has a tapered profile, and the tapered profile guides the reconstituted reagent toward the access port.

In Example 19, the subject matter of any one or more of Examples 1-18 optionally include wherein the cartridge body includes one or more of polypropylene, polystyrene, acrylic, polyolefin, or Topas®.

Example 20 is a reagent cartridge comprising: a cartridge body configured to store a reagent component, the cartridge body includes: a first end portion; a second end portion; at least one cartridge wall surrounding at least a portion of a reagent envelope, the reagent envelope configured for storage of the reagent component; and a first shelf surrounding an access port at the first end of the cartridge body, the first access port in communication with the reagent envelope; a first seal coupled with the first shelf and the first seal closes the first access port and the first end portion of the cartridge body, wherein the seal and the cartridge body cooperatively isolate the reagent envelope from an environment exterior to the reagent envelope; and wherein the second end portion of the cartridge body is selectively openable.

In Example 21, the subject matter of Example 20 optionally includes wherein the second end portion of the cartridge body has a fracture locus to facilitate selective opening of the reagent cartridge.

In Example 22, the subject matter of any one or more of Examples 20-21 optionally include wherein the second end portion of the cartridge body has a second seal closing the second end portion of the cartridge body, and the seal is puncturable or removeable to facilitate selective opening of the reagent cartridge.

In Example 23, the subject matter of Example 22 optionally includes wherein the second end of the cartridge body has a second access port surrounded by a second shelf, and the second seal is coupled with the second shelf to close the second access port.

In Example 24, the subject matter of any one or more of Examples 20-23 optionally include wherein the access port is configured to receive a penetrating element to evacuate a reconstituted reagent, the reconstituted reagent including a diluent and the reagent component.

In Example 25, the subject matter of any one or more of Examples 20-24 optionally include wherein the reagent cartridge has a reconstitution configuration and an extraction configuration: in the reconstitution configuration, the access port is opened and the reagent envelope and reagent component therein are configurated to receive a diluent through the access port; and in extraction configuration, the second end portion is opened and the reagent reconstituted in the reconstitution configuration is delivered through the open second end portion.

In Example 26, the subject matter of Example 25 optionally includes wherein the reagent reconstituted in the reconstitution configuration is delivered away from the first end portion and through the second end portion.

Example 27 is a method of using a reagent cartridge, comprising: unsealing a first end portion of the reagent cartridge to access a reagent envelope, the reagent envelope containing a reagent component; reconstituting the reagent component, including: introducing a diluent through the first end portion and a first access port in communication with the reagent envelope; and reconstituting the reagent component with the diluent in the reagent envelope; and evacuating reconstituted reagent through a second access port in communication with the reagent envelope.

In Example 28, the subject matter of Example 27 optionally includes wherein evacuating reconstituted reagent from the reagent envelope includes: unsealing a second end portion of the reagent cartridge to access the reagent envelope, wherein the second end portion of the reagent cartridge has the second access port; evacuating the reconstituted reagent through the second access port.

In Example 29, the subject matter of any one or more of Examples 27-28 optionally include unsealing a second end portion of the reagent cartridge to access the reagent envelope.

In Example 30, the subject matter of Example 29 optionally includes wherein unsealing the second end portion of the reagent cartridge includes fracturing the reagent cartridge at a fracture locus.

In Example 31, the subject matter of any one or more of Examples 29-30 optionally include wherein unsealing the first end portion of the reagent cartridge includes piercing a seal.

In Example 32, the subject matter of any one or more of Examples 27-31 optionally include wherein unsealing the first end portion of the reagent cartridge includes removing a seal from the reagent cartridge.

In Example 33, the subject matter of any one or more of Examples 27-32 optionally include passing an instrument through an access port at the first end portion of the reagent cartridge.

Each of these non-limiting examples can stand on its own, or can be combined in various permutations or combinations with one or more of the other examples.

The above description includes references to the accompanying drawings, which form a part of the detailed description. The drawings show, by way of illustration, specific embodiments in which the invention can be practiced. These embodiments are also referred to herein as “examples. ” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F. R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A reagent cartridge comprising:
a cartridge body configured to store a reagent component, the cartridge body includes:
at least one cartridge wall surrounding at least a portion of a reagent envelope, the reagent envelope configured for storage of the reagent component; and
a shelf surrounding an access port, the access port in communication with the reagent envelope; and
a seal coupled with the shelf and the seal closes the access port, wherein the seal and the cartridge body cooperatively isolate the reagent envelope from an environment exterior to the reagent envelope.

2. The reagent cartridge of claim 1, wherein:
the shelf includes a first shelf and a second shelf,
the access port includes a first access port and a second access port;
the first shelf surrounds the first access port;
the second shelf surrounds the second access port;
the seal includes a first seal and a second seal;
the first seal is coupled with the first shelf, and the first seal closes the first access port; and
the second seal is coupled with the second shelf, and the second seal closes the second access port.

3. The reagent cartridge of claim 1, wherein the at least one cartridge wall has a tapered profile.

4. The reagent cartridge of claim 3, wherein the tapered profile narrows toward the access port.

5. The reagent cartridge of claim 3, wherein the tapered profile widens toward the access port.

6. The reagent cartridge of claim 1, wherein the cartridge body has an indexing feature configured to orient the reagent cartridge with respect to a reconstitution assembly.

7. The reagent cartridge of claim 6, wherein the indexing feature includes at least one of a key provided on the cartridge body or a keyway provided on the cartridge body.

8. (canceled)

9. The reagent cartridge of claim 6, wherein the shelf includes a flange extending away from the at least one cartridge wall, and the indexing feature is included in the flange.

10. The reagent cartridge of claim 1, wherein the cartridge body includes a fracture locus, and the fracture locus is configured to preferentially fracture proximate an end of the cartridge body.

11. The reagent cartridge of claim 10, wherein the at least one cartridge wall has a tapered profile, and the tapered profile guides reconstituted reagent toward the fracture locus.

12. The reagent cartridge of claim 1, wherein the shelf includes a flange extending away from the at least one cartridge wall and the shelf extends between an inner wall surface and an outer wall surface.

13. (canceled)

14. (canceled)

15. The reagent cartridge of claim 1, wherein:
the shelf includes a first shelf and a second shelf;
the access port includes a first access port and a second access port;
the first shelf surrounds the first access port;
the second shelf surrounds the second access port;
the first access port is configured to receive a first penetrating element to provide a diluent to the reagent component; and
the second access port is configured to receive a second penetrating element to evacuate a reconstituted reagent from the reagent envelope, the reconstituted reagent including the diluent and the reagent component.

16. (canceled)

17. (canceled)

18. The reagent cartridge of claim 15, wherein the at least one cartridge wall has a tapered profile, and the tapered profile guides the reconstituted reagent toward the access port.

19. The reagent cartridge of claim 1, wherein the cartridge body includes one or more of polypropylene, polystyrene, acrylic, polyolefin, or Topas®.

20. A reagent cartridge comprising:
a cartridge body configured to store a reagent component, the cartridge body includes:
a first end portion;
a second end portion;
at least one cartridge wall surrounding at least a portion of a reagent envelope, the reagent envelope configured for storage of the reagent component; and
a first shelf surrounding a first access port at the first end portion of the cartridge body, the first access port in communication with the reagent envelope;
a first seal coupled with the first shelf and the first seal closes the first access port and the first end portion of the cartridge body, wherein the first seal and the cartridge body cooperatively isolate the reagent envelope from an environment exterior to the reagent envelope; and
wherein the second end portion of the cartridge body is selectively openable.

21. The reagent cartridge of claim 20, wherein the second end portion of the cartridge body has a fracture locus to facilitate selective opening of the reagent cartridge.

22. The reagent cartridge of claim 20, wherein the second end portion of the cartridge body has a second seal closing the second end portion of the cartridge body, the second seal being puncturable or removeable to facilitate selective opening of the reagent cartridge; and
wherein the second end portion of the cartridge body has a second access port surrounded by a second shelf, and the second seal is coupled with the second shelf to close the second access port.

23. (canceled)

24. The reagent cartridge of claim 20, wherein the first access port is configured to receive a penetrating element to evacuate a reconstituted reagent, the reconstituted reagent including a diluent and the reagent component.

25. The reagent cartridge of claim 20, wherein the reagent cartridge has a reconstitution configuration and an extraction configuration:
in the reconstitution configuration, the first access port is opened and the reagent envelope and the reagent component therein are configurated to receive a diluent through the first access port; and
in the extraction configuration, the second end portion is opened and the reagent component reconstituted in the reconstitution configuration is delivered through the opened second end portion and away from the first end portion.

26. (canceled)

27. A method of using a reagent cartridge, comprising:
unsealing a first end portion of the reagent cartridge to access a reagent envelope, the reagent envelope containing a reagent component;
reconstituting the reagent component, including:
introducing a diluent through the first end portion and a first access port in communication with the reagent envelope; and
reconstituting the reagent component with the diluent in the reagent envelope; and
evacuating the reconstituted reagent component through a second access port in communication with the reagent envelope.

28. The method of claim 27, wherein evacuating reconstituted reagent from the reagent envelope includes:
unsealing a second end portion of the reagent cartridge to access the reagent envelope, wherein the second end portion of the reagent cartridge has the second access port;
evacuating the reconstituted reagent component through the second access port.

29. The method of claim 27, further comprising unsealing a second end portion of the reagent cartridge to access the reagent envelope.

30. The method of claim 29, wherein unsealing the second end portion of the reagent cartridge includes fracturing the reagent cartridge at a fracture locus.

31. The method of claim 29, wherein unsealing the first end portion of the reagent cartridge includes at least one of piercing a seal or removing the seal from the reagent cartridge.

32. (canceled)

33. The method of claim 27, further comprising passing an instrument through an access port at the first end portion of the reagent cartridge.
